(19) United States
(12) Patent Application Publication
(10) Pub. No.: US 2011/0030195 A1
(43) Pub. Date: Feb. 10, 2011

(54) AERATION PAD INSTALLATION TOOL

(76) Inventor: Larry Franssen, Milford, NE (US)

Correspondence Address: GREER, BURNS & CRAIN, 300 S WACKER DR, 25TH FLOOR, CHICAGO, IL, 60606, US

(21) Appl. No.: 12/537,581

(22) Filed: Aug. 7, 2009

(51) Int. Cl. B25B 27/14; B23P 11/00

(52) U.S. Cl. 29/525.11; 29/270

(57) ABSTRACT

A tool for installing an aeration pad into a discharge vessel, the aeration pad having a rubber boot abutting the inside surface of the discharge vessel and a threaded pipe portion extending through an opening of the discharge vessel, the pipe having outside threads of a first predetermined size and inside threads of a second predetermined size. The tool includes an elongated cylindrical main body having a first end portion and a second end portion, an elongated secondary body pivotably connected to the main body, with a first end portion and a second end portion, the first end portion having a pivot connection to the main body and a threaded portion at the second end portion thereof, the threaded portion having threads of the second predetermined size for attachment to an aeration pad.

### BACKGROUND OF THE INVENTION

This invention relates generally to installation of aeration pads in a discharge vessel, and more specifically to a tool for installing aeration pads.

During discharge of material from a tank, bin or hopper, the material may clot or hang-up which results in reduced or even no flow of the material. Aeration pads are commonly used in such tanks to increase flow rates of the material out of the tank, and therefore, facilitate discharge of the material. An example of such a device is the VIBRA PAD by Cyclonaire Corp. This device is installed into an opening on the tank and provides increased flow rates by aerating the material in the tank and producing a resonating vibratory wave into the discharge element.

Typically, aeration pads are installed by feeding a fish tape though an opening in the tank wall to an outlet near the tank discharge area. The pad is then hooked onto the line and pulled through the tank and back through the opening. At this point, the pad is usually secured in the opening using a nut. However, once the pad is inserted through the opening, it must be held to prevent it from falling back through the opening while the nut is tightened. This traditional process can be time consuming since it is difficult for one to tighten the nut while holding the pad to prevent it from falling back into the tank. Due to the non-flexible nature of the aeration pad, one may also experience difficulty guiding the pad into the vessel opening. Accordingly, there is a need for an improved aeration pad installation tool which addresses the above deficiencies of conventional aeration pad insertion techniques.

### SUMMARY OF THE INVENTION

Embodiments of the present invention are directed to an aeration pad installation tool and a method for installing an aeration pad. More specifically, a preferred embodiment is directed to a tool for installing an aeration pad into a discharge vessel, the aeration pad having a rubber boot abutting the inside surface of the discharge vessel and a threaded pipe portion extending through an opening of the discharge vessel, the pipe having outside threads of a first predetermined size and inside threads of a second predetermined size. The tool includes an elongated cylindrical main body having a first end portion and a second end portion, an elongated secondary body pivotably connected to the main body, with a first end portion and a second end portion, the first end portion having a pivot connection to the main body and a threaded portion at the second end portion thereof, the threaded portion having threads of the second predetermined size for attachment to an aeration pad.

A method for installing an aeration pad in a discharge vessel including an aeration opening and using an installation tool, the tool comprising a guide attachment section including a pivot connection, and a threaded section pivotably attached to the pivot connection is also provided. The method includes the steps of threading the tool through the aeration opening using a guide such that the tool is accessible through a bottom opening of the discharge vessel; attaching the aeration pad to the threaded section; using the guide to pull the tool through the aeration opening until the aeration pad is adjacent to an inner surface of the vessel; removing the guide from the guide attachment section; sliding a securing assembly along the tool towards the aeration pad; pivoting the guide attachment section about the pivot connection so that the guide attachment section is approximately perpendicular to the threaded section; tightening the securing assembly against the aeration pad while using the tool to hold the aeration pad in place; and unscrewing the tool from the aeration pad.

### BRIEF DESCRIPTION OF THE DRAWINGS

FIG. 1 is a side elevation view of a preferred embodiment of an aeration pad installation tool;

FIG. 2 is a side elevation view of the present aeration pad installation tool with the secondary body pivoted approximately 90 degrees about a longitudinal axis parallel to the main body;

FIG. 3 is a top view of the main body of the installation tool of FIG. 1;

FIG. 4 is a side elevation view the secondary body of the installation tool of FIG. 1;

FIG. 5 is a partially fragmentary side view of an aeration pad installed in a discharge vessel;

FIG. 6A is front view of the aeration pad being installed in the discharge vessel using the tool of FIG. 1 showing the guide pulling the tool and attached aeration pad through the aeration opening;

FIG. 6B is front view of the aeration pad being installed in the discharge vessel using the tool of FIG. 1 showing a securing assembly being slid along the tool towards the aeration pad; and

FIG. 6C is front view of the aeration pad being installed in the discharge vessel using the tool of FIG. 1 where the guide attachment section is approximately perpendicular to the threaded section.

### DETAILED DESCRIPTION OF THE EMBODIMENTS

In the preferred embodiment, an aeration pad installation tool is provided that facilitates installation of an aeration pad into a discharge vessel. The tool connects to the aeration pad and pivots to form a T-shaped handle so that the aeration pad can be held in place with the tool while the pad is secured to a discharge vessel. Additionally, the pivoting action of the tool makes the tool self guiding when it is pulled into an opening in the vessel wall using a tether.

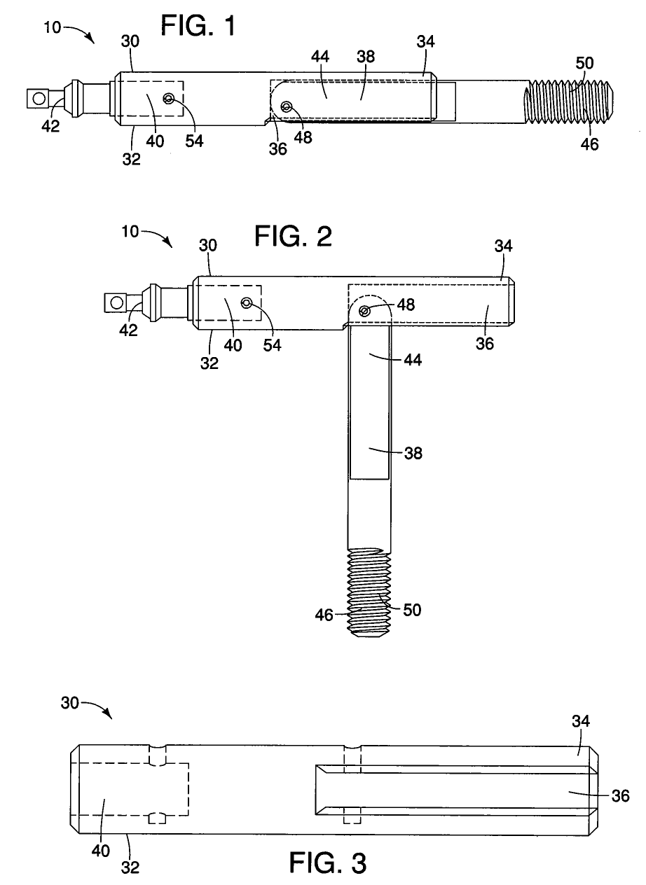

Referring now to FIGS. 1 and 5, an aeration pad installation tool is generally designated as 10 and is used for installing an aeration pad 12 into a discharge vessel 14. The aeration pad 12 has a rubber boot 16 abutting the inside surface 18 of the discharge vessel 14 and a threaded pipe portion 20 extending through an opening 22 of the discharge vessel. The pipe 24 has outside threads 26 of a first predetermined size and inside threads (not shown) of a second predetermined size. Additionally, the tool 10 has a thin configuration to fit within the opening 22 located on the discharge vessel 14 wall 18.

As show in FIGS. 1-3, the installation tool includes a main body 30 having a first end 32 and a second end 34. The main body 16 is generally elongated and includes a slot 36 for receiving a secondary body 38. The slot 36 is located on the second end 34 and is appropriately sized to accommodate the secondary body 38. As best shown in FIG. 3, the slot 36 extends from approximately a midway between the main body 30 first 32 and second ends 34 to the second end. Also included in the main body 30 first end 32 is a recess 40 at the first end 32 configured for receiving a connecting device 40.

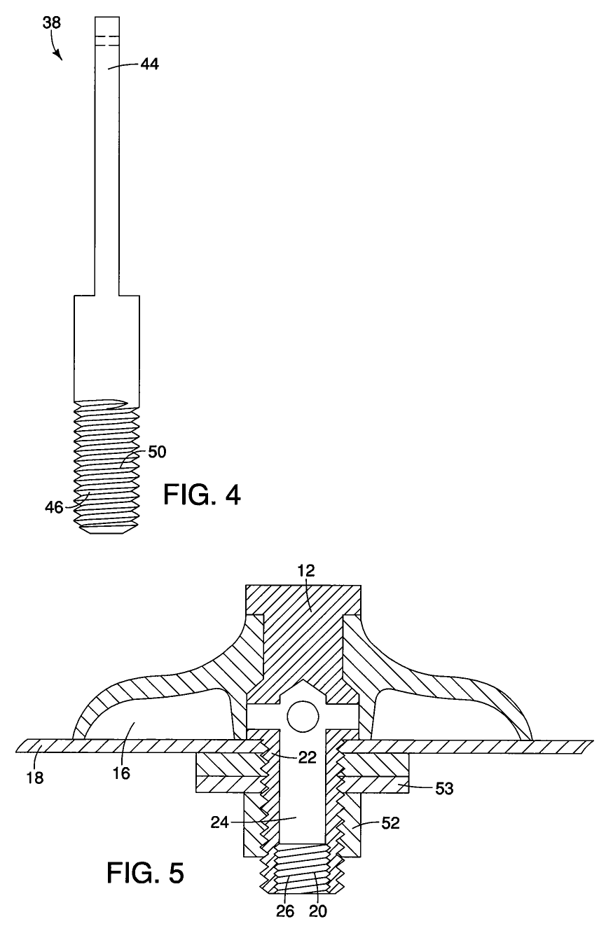

Turning now to FIGS. 1, 2 and 4, the secondary body 38 includes a first end portion 44 and second end portion 46 and is configured for engaging the slot 36 on the main body 30. When the main body 30 and secondary body 38 are in a straight or neutral position, as shown in FIG. 1, in the preferred configuration, the secondary body 38 extends beyond the main body 30 second end 34. It is also contemplated that the main body 30 second end 34 extend beyond the secondary body 38 second end portion 46 or that the main body second end and secondary body second end portion terminate at the same location.

The first end portion 44 also has a pivot connector 48 to the main body 30. Preferably, the pivot connection 48 connects the secondary body 38 first end portion 44 to the main body 30 approximately at a midway between the first 32 and second 34 end portions of the main body. However, other connection positions 48 are contemplated. As such, the secondary body 38 pivots about ninety degrees relative to the main body 30 about an axis parallel to the main body as shown in FIG. 2. When the tool 10 is in a pivoted position shown in FIG. 2, a T-shaped handle is formed so that the aeration pad 12 can be held in place with the tool while the pad is secured to the discharge vessel 14.

The secondary body 38 second end 46 includes a threaded portion 50 having threads of the second predetermined size for attachment to the aeration pad 12. The ability of the tool 10 to connect to the pad 12 allows the pad to be held in place while being secured to the vessel wall 18. Additionally, an outer diameter of the main 30 and secondary 38 bodies, when straight, is less than the first predetermined size so that a fastener 52 can fit over the tool 10 and be screwed onto the threaded pipe 24. Preferably the fastener 52 is a nut. A washer 53 may also be included with the nut 52. Other fasteners 52 are also contemplated based on the aeration pad 12 design.

Once the secondary body 38 is in a pivoted position, the T-shaped handle formed is used to secure the aeration pad 12 in place so that the nut 52 and washer 53 can be tightened around the outside threads 26 of the pipe 24. After the nut 52 is in place, the aeration pad 12 is secured against the discharge vessel 14 and the tool can be removed from the inner threads of the aeration pad 12.

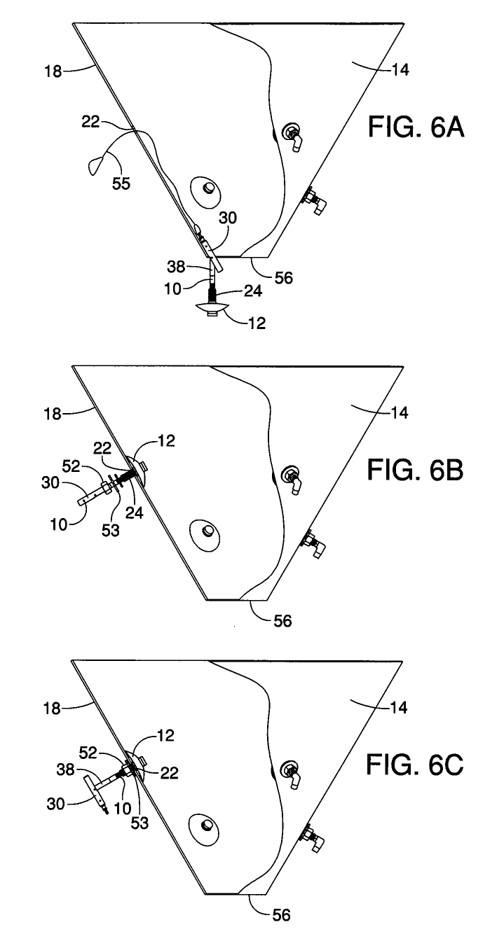

Referring now to FIGS. 1-3, the main body 30 recess 40 is located at the first end 32 and is configured for receiving the connecting device 42. The connecting device 42 is secured to the main body 30 using a pin 54 or other suitable connecting mechanism. Preferably, the connecting device 42 is cylindrical and includes a detachable tether 55 as shown in FIG. 6A. Accordingly, the recess 40 should be cylindrically sized for receiving the connecting device 42. Additional shapes for the recess 40 and connecting device 42 are contemplated based on design preference.

The tether 55 is used to guide the tool 10 and attached aeration pad 12 into the opening 22. In the preferred configuration, the tether 55 is a string of sufficient strength to support the combined weight of the tool 10 and attached aeration pad 12. However, other materials and shapes are contemplated for the tether 55. As should be appreciated, the pivoting action of the tool 10 makes the tool self guiding when it is pulled into the opening 22 using the tether 55.

A method for installing the aeration pad 12 into the discharge vessel 14 using the installation tool 10 will now be described in conjunction with FIGS. 6A-C. As shown in FIG. 6A, first the tool 10 is dropped through the aeration opening 22 using a tether 55 until the tool is accessible through a bottom opening 56 of the discharge vessel 14. Next, the inside threads of the aeration pad 12 are attached to the secondary body 20 threaded portion 50, and the tether 55 is used to pull the tool 10 through the aeration opening 22 until the aeration pad is adjacent to the inner surface 18 of the vessel 14. The pivoting action of the tool 10 facilitates guiding the tool and connected aeration pad 12 into the opening 22. Referring now to FIG. 6B, once the aeration pad 12 and connected tool 10 are though the opening 22, the tether 55 is removed from the main body 30 and the nut 52 and optional washer 23 are slid along the tool 10 towards the aeration pad 12 pipe portion 24. As best shown in FIG. 6C, the main body 30 is then pivoted about the pivot connection 48 so that the main body is approximately perpendicular to the secondary body 38. The T-handle is formed and is then used to hold the aeration pad in place while the nut 52 is tightened around the outside threads 26. Once the nut 52 is tight, the threaded portion 50 is unscrewed from the inside threads and the aeration pad 12 is left installed in the discharge vessel 14.

While various embodiments of the present invention have been shown and described, it should be understood that other modifications, substitutions and alternatives are apparent to one of ordinary skill in the art. Such modifications, substitutions and alternatives can be made without departing from the spirit and scope of the invention, which should be determined from the appended claims.

Various features of the invention are set forth in the following claims.

What is claimed is:

1. A tool for installing an aeration pad into a discharge vessel, the aeration pad having a rubber boot abutting the inside surface of the discharge vessel and a threaded pipe portion extending through an opening of the discharge vessel, the pipe having outside threads of a first predetermined size and inside threads of a second predetermined size, said tool comprising:
an elongated cylindrical main body having a first end portion and a second end portion;
an elongated secondary body pivotably connected to said main body, with a first end portion and a second end portion, said first end portion having a pivot connection to said main body and a threaded portion at said second end portion thereof, said threaded portion having threads of said second predetermined size for attachment to an aeration pad.

2. A tool as defined in claim 1 wherein said pivot connection connects said secondary body first end portion to said main body approximately at a midway between said first and second end portions thereof.

3. A tool as defined in claim 1 wherein said main body further comprises a recess at said first end portion for receiving a connecting device.

4. The tool as defined in claim 3 wherein said recess is cylindrically sized and configured to receive said connecting device.

5. The tool as defined in claim 4 wherein said connecting device is a cylindrical device configured to fit within the recess and having a detachable tether.

6. The tool as defined in claim 4 further comprising a pin to retain said connecting device in said recess.

7. The tool as defined in claim 1 wherein said main body includes a slot for receiving said secondary body, said slot extending from approximately at a midway between said main body first and second end portions to said second end portion.

8. The tool as defined in claim 1 wherein said main body extends beyond said secondary body second end portion.

9. The tool as defined in claim 1 wherein said secondary body extends beyond said main body second end portion.

10. The tool as defined in claim 1 wherein said tool has a thin configuration to fit within a slot located on a discharge vessel wall.

11. The tool as defined in claim 1 wherein said secondary body pivots at least about 90 degrees relative to said main body.

12. The tool as defined in claim 1 wherein an outer diameter of said main and secondary bodies when straight are less than said first predetermined size so that a nut can fit over said tool and be screwed onto said threaded pipe.

13. A tool for installing an aeration pad into a discharge vessel, comprising:
a main section which includes a first end and a second end, said first end including a means for attaching a threaded guide;
a threaded section which includes a first end and a second end, said second end including a threaded portion for attaching an aeration pad; and
a pivot connection located in a middle portion of said main section, said pivot connection pivotably attached to said threaded section first end to accommodate pivoting of said threaded section about said pivot connection between a position parallel with a longitudinal axis of said main section and a position approximately perpendicular to the longitudinal axis of said main section.

14. The tool of claim 14 wherein said main section further includes a cavity for receiving said means for attaching a threaded guide.

15. The tool of claim 15 wherein said means for attaching a threaded guide is detachable from said main section.

16. A method for installing an aeration pad in a discharge vessel including an aeration opening and using an installation tool, said tool comprising a guide attachment section including a pivot connection, and a threaded section pivotably attached to said pivot connection, said method comprising the steps of:
threading said tool through the aeration opening using a guide such that said tool is accessible through a bottom opening of the discharge vessel;
attaching the aeration pad to said threaded section;
using the guide to pull said tool through the aeration opening until the aeration pad is adjacent to an inner surface of the vessel;
removing the guide from said guide attachment section;
sliding a securing assembly along said tool towards the aeration pad;
pivoting said guide attachment section about said pivot connection so that said guide attachment section is approximately perpendicular to said threaded section;
tightening the securing assembly against the aeration pad while using said tool to hold the aeration pad in place; and
unscrewing said tool from the aeration pad.

17. The method of claim 17 wherein said securing assembly includes a washer and a nut.

18. The method of claim 17 wherein a diameter of said tool is smaller than the diameter of the aeration hole.

19. The method of claim 17 wherein said guide is a string sufficiently strong to support said aeration pad.
